(19) United States
(12) Patent Application Publication
(10) Pub. No.: US 2024/0165436 A1
(43) Pub. Date: May 23, 2024

(54) GARMENT WITH ADJUSTABLE EXTREMITIES

(71) Applicant: Lion Group, Inc., Dayton, OH (US)

(72) Inventors: Kathryn Ann YORK, Tipp City, OH (US); Calvin Clark BRANT, Dayton, OH (US)

(21) Appl. No.: 18/514,359

(22) Filed: Nov. 20, 2023

Related U.S. Application Data
(60) Provisional application No. 63/426,889, filed on Nov. 21, 2022.

(51) Int. Cl. A62B 17/00

(52) U.S. Cl. CPC A62B 17/003; A62B 17/001

(57) ABSTRACT

A protective garment including a body portion, an extremity portion coupled to the body portion and being shaped and configured to receive a leg or an arm of a wearer therein, and a piece of expansion material coupled to the extremity portion. The piece of expansion material is movable between a retracted position wherein the extremity portion is configured to form relatively smaller fit about the wearer's leg or arm, and an expanded position wherein the extremity portion is configured to form a relatively larger fit about the wearer's leg or arm. The garment further includes a biasing device configured to bias the piece of expansion material to the retracted position, and a retaining system configured to releasably retain the piece of expansion material in the retracted position.

This application claims priority to U.S. Provisional Patent Application Ser. No. 63/426,889, filed on Nov. 21, 2022 and entitled Garment with Adjustable Extremities, the entire contents of which are hereby incorporated by reference.

This application relates to protective garments, and more particularly, to protective trousers or coats with adjustable extremities, such as legs or arms.

### BACKGROUND

Protective or hazardous duty garments used in a variety of industries and settings to protect the wearer from hazardous conditions such as heat, smoke, cold, sharp objects, chemicals, liquids, fumes and the like. However, existing garments may not provide at satisfactory fit at the extremities, such as at the arms and legs.

### SUMMARY

In one embodiment the invention is a protective garment having extremities that are adjustable to vary the fit of the garment. In one case, the invention is a protective garment including a body portion, an extremity portion coupled to the body portion and being shaped and configured to receive a leg or an arm of a wearer therein, and a piece of expansion material coupled to the extremity portion. The piece of expansion material is movable between a retracted position wherein the extremity portion is configured to form relatively smaller fit about the wearer's leg or arm, and an expanded position wherein the extremity portion is configured to form a relatively larger fit about the wearer's leg or arm. The garment further includes a biasing device configured to bias the piece of expansion material to the retracted position, and a retaining system configured to releasably retain the piece of expansion material in the retracted position.

### BRIEF DESCRIPTION OF DRAWINGS

FIG. 1 is front perspective view of a coat, with portions of various layers cut away for illustrative purposes;

FIG. 2 is front perspective view of a pair of trousers, with portions of various layers cut away for illustrative purposes;

FIG. 3 is a detail view of the lower portion of a leg of the trousers of FIG. 1, with the leg in a retracted position;

FIG. 4 shows the leg portion of FIG. 3 in an expanded position;

FIG. 5 shows the leg portion of FIG. 3, from a view inside the trousers;

FIG. 6 shows the leg portion of FIG. 4, from a view inside the trousers;

FIG. 7 is a bottom cross section of the leg portion of FIG. 3;

FIG. 8 is a bottom cross section of the leg portion of FIG. 4;

FIG. 9 shows an alternate version of the leg portion of FIG. 5;

FIG. 10 shows an alternative version of the leg portion of FIG. 6;

FIG. 11 shows another alternative version of the leg portion of FIG. 6;

FIG. 12 shows another alternative version of the leg portion of FIG. 5; and

FIG. 13 shows another alternative version of the leg portion of FIG. 5.

### DETAILED DESCRIPTION

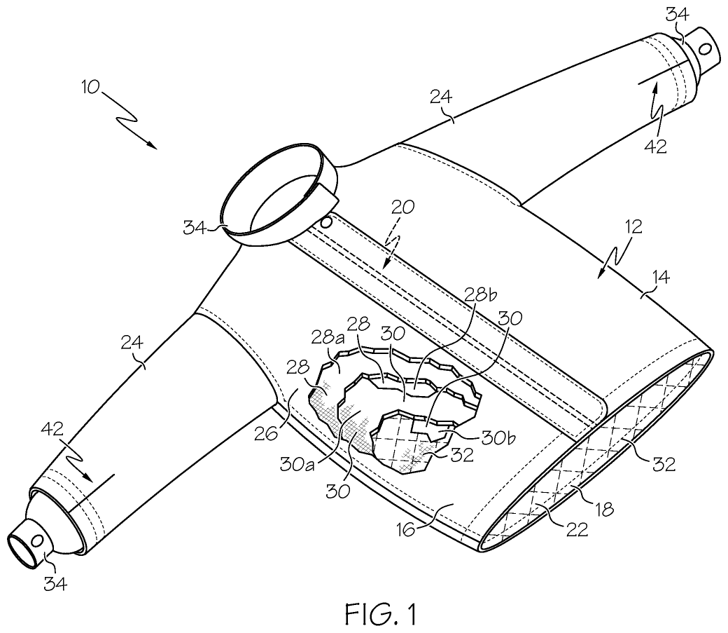

FIG. 1 illustrates a protective or hazardous duty garment in the form of a firefighter's coat, generally designated 10. The coat 10 may include a body portion 12 having a left front panel 14, right front panel 16 and a back panel 18. The left front panel 14 and right front panel 16 may be releasably attachable by a garment fastener 20, such as a zipper, snaps, clasps, buttons, magnets (or magnets with magnetizable strike plates), clips, hook-and-loop fastening material (i.e., VELCRO® fastening material), combinations of these components or the like. The body portion 12 may define a torso cavity 22 that is shaped and configured to receive a wearer's torso therein. The coat 10 may include a pair of extremities or extremity portions, in the form of arms or sleeves 24 coupled to and extending generally outwardly from the body portion 12 and shaped and configured to receive a wearer's arms therein. Each sleeve 24 can be generally tubular (e.g., in one case, tubular, cylindrically or generally cylindrical but somewhat collapsed and/or deformed to the natural bending and pliability of the material of the sleeves 24) and be configured to cover at least about 90% of the arm of a wearer.

The coat 10 may include various layers through its thickness to provide various heat, moisture and/or abrasion resistant qualities to the coat 10 so that the coat 10 can be used as a protective, hazardous duty, and/or firefighter garment. For example, the coat 10 may include an outer shell, outer layer or outer material 26, a moisture barrier 28 located inside of and adjacent to the outer shell 26 (e.g. positioned between the outer shell 26 and the torso cavity 22), a thermal liner or barrier 30 located inside of and adjacent to the moisture barrier 28, and an inner liner or face cloth 32 located inside of and adjacent to the thermal barrier 30.

The outer shell 26 may be made of or include a variety of materials, including a flame, heat and abrasion resistant material such as a compact weave of aramid fibers and/or polybenzamidazole fibers. Commercially available aramid materials include NOMEX and KEVLAR fibers (both trademarks of E.I. DuPont de Nemours & Co., Inc. of Wilmington, Delaware), and commercially available polybenzamidazole fibers include PBI fibers (a trademark of PBI Performance Fabrics of Charlotte, North Carolina). Thus, the outer shell 26 may be an aramid material, a blend of aramid materials, a polybenzamidazole material, a blend of polybenzamidazole fibers, a blend of aramid and polybenzamidazole materials, a poly-phenylene benzobisoxazole (PBO) material, a thermostable organic polymer material, such as KERMEL® material sold by Kermel SAS of Colmar, France, a blend of any of the materials listed above, or other appropriate materials.

If desired, the outer shell 26 may be coated with a polymer, such as a durable, water repellent finish or coating (i.e. a perfluorohydrocarbon finish, such as TEFLON® finish sold by E. I. Du Pont de Nemours and Company of Wilmington, Delaware, or a fluorine free water repellent finish). The materials of the outer shell 26 may have a weight of, for example, between about five and about ten oz./yd². Moreover, if desired the outer shell 26 may have a self-decontaminating finish or coating applied thereto.

The moisture barrier 28 and thermal barrier 30 may be generally coextensive with the outer shell 26, or spaced slightly inwardly from the outer edges of the outer shell 26 (i.e., spaced slightly inwardly from the outer ends of the sleeves 24 and/or from the lower edge or hem of the coat 10) to provide moisture and thermal protection throughout the coat 10. The moisture barrier 28 may include a semi-permeable membrane layer 28a and a substrate 28b.

The membrane layer 28a may be generally water vapor permeable but generally impermeable to liquid moisture. The membrane layer 28a may be made of or include expanded polytetrafluoroethylene (“PTFE”) such as GORE-TEX or CROSSTECH materials (both of which are trademarks of W.L. Gore & Associates, Inc. of Newark, Delaware), polyurethane-based materials, neoprene-based materials, cross-linked polymers, polyamid, or other materials. The membrane layer 28a may have microscopic openings that permit moisture vapor (such as water vapor) to pass therethrough, but block liquids (such as liquid water) from passing therethrough. The membrane layer 28a may be made of a microporous material that is either hydrophilic, hydrophobic, or somewhere in between. The membrane layer 28a may also be monolithic and may allow moisture vapor transmission therethrough by molecular diffusion. The membrane layer 28a may also be a combination of microporous and monolithic materials (known as a bicomponent moisture barrier), in which the microporous or monolithic materials are layered or intertwined.

The membrane layer 28a may be bonded, adhered or otherwise coupled to a substrate 28b of a flame and heat resistant material to provide structure and protection to the membrane layer 28a. Thus, either the membrane layer 28a alone, or the membrane layer 28a in combination with the moisture barrier substrate 28b, may be considered to constitute the moisture barrier 28. The substrate 28b may be or include aramid fibers similar to the aramid fibers of the outer shell 26, but may be thinner and lighter in weight. The substrate 28b may be woven, non-woven, spunlace or other materials. In the illustrated embodiment, the membrane layer 28a is located between the outer shell 26 and the substrate 28b. However, the orientation of the moisture barrier 28 may be reversed such that the substrate 28b is located between the outer shell 26 and the membrane layer 28a.

The thermal barrier 30 may be made of nearly any suitable flame resistant material that provides sufficient thermal insulation. In one embodiment, the thermal barrier 30 may include a layer of bulk material 30a in the form of relatively thick (i.e. between about 1/16″- 3/16″) batting, felt or needled non-woven bulk or batting material. The bulk material 30a can include aramid fiber batting (such as NOMEX batting), aramid needlepunch material, an aramid non-woven material, an aramid blend needlepunch material, an aramid blend batting material, an aramid blend non-woven material, foam (either open cell or closed cell), or other suitably thermally insulating materials. The bulk material 30a may trap air and possess sufficient loft to provide thermal resistance to the coat 10.

The bulk material 30a may be quilted or otherwise coupled to a thermal barrier face cloth 30b which can be a weave of a lightweight aramid material. Thus, either the bulk material 30a alone, or the bulk material 30a in combination with the thermal barrier face cloth 30b, may be considered to constitute the thermal barrier 30. In the illustrated embodiment, the thermal barrier bulk material 30a is located between the outer shell 26 and the thermal barrier face cloth 30b. However, the orientation of the thermal barrier 30 may be reversed such that the thermal barrier face cloth 30b is located between the outer shell 26 and the bulk layer 30a. If desired, the thermal barrier 30 may be treated with a water-resistant or water-repellent finish. In one embodiment, the thermal barrier 30 (or the coat 10 as a whole) may have a thermal protection performance (“TPP”) of at least about twenty, and the coat 10 as a whole may have a TPP of at least about thirty-five, although the TPP values can vary.

Although the moisture barrier 28 is shown as being located between the outer shell 26 and the thermal barrier 30, the positions of the moisture barrier 28 and thermal barrier 30 may be reversed such that the thermal barrier 30 is located between the outer shell 26 and the moisture barrier 28, or additional moisture barrier 28 and/or thermal barrier layers 30 can be utilized or various other orientations or configurations may be used.

The face cloth 32 may be the innermost layer of the coat 10 and configured to contact the wearer and/or the wearer's clothing, located inside the thermal barrier 30 and moisture barrier 28. The face cloth 32 can provide a comfortable surface for the wearer and protect the thermal barrier 30 and/or moisture barrier 28 from abrasion and wear. The face cloth 32 may be quilted to the adjacent layer (i.e. the thermal barrier 30 in the illustrated embodiment). However, the face cloth 32 is optional and may be excluded if desired. In addition, the coat 10 may not necessarily include the moisture barrier 28 and/or the thermal barrier 30 in certain cases. The coat 10 can include wristlets 34 located at a distal end of the sleeve 24. The wristlets 34 can be made of a knit, stretchable material.

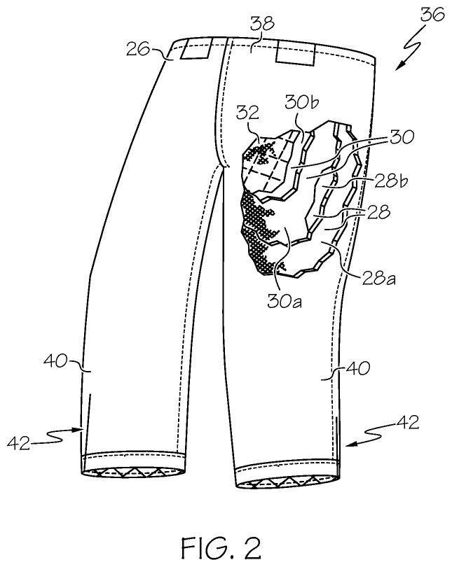

FIG. 2 illustrates a pair of trousers 36 that may be able to be used in conjunction with or separately from the coat 10. The trousers 36 can include a body portion 38 configured to receive the pelvis and/or lower portion of a wearer's torso therein. The trousers 36 include a pair of legs or extremities/extremity portions 40 that are coupled to the body portion 38 and extend away therefrom, and are shaped and configured to receive a wearer's legs therein. Each leg 40 can be generally tubular and be configured to cover at least about 90% of the leg of a wearer. The trousers 36 can be made of the same materials and layers, and in the various configurations with the same qualities as the coat 10 outlined above.

Each layer of the coat 10 and trousers 36 disclosed herein, including the layers and components described above, as well as those described below, and the coat 10 or trousers 36 as a whole, may meet the National Fire Protection Association (“NFPA”) 1971 standards for protective firefighting garments (“Protective Clothing for Structural Firefighting”), which standards as of the filing date of this application are entirely incorporated by reference herein. The NFPA standards specify various minimum requirements for heat and flame resistance and tear strength. For example, in order to meet the NFPA standards, the outer shell 26, moisture barrier 28, thermal barrier 30 and face cloth 32 must be able to resist igniting, burning, melting, dripping, separation, and/or shrinking more than 10% in any direction after being exposed to a temperature of 500° F. for at least five minutes. Furthermore, in order to meet the NFPA standards, the combined layers of the coat 10 and/or trousers 36 must provide a thermal protective performance rating of at least thirty-five.

Alternately or in addition to the NFPA Standard 1971, the coat 10 and/or trousers 36 may meet European Norm (“EN”) standards for firefighting garments set by the European Committee for Standardization (also known as Comité Européen de Normalisation (“CEN”)). These standards include EN 469:2005 Level 1 and Level 2 certification. The EN standards for firefighter and protective garments in place as of the filing date of this application are entirely incorporated by reference herein.

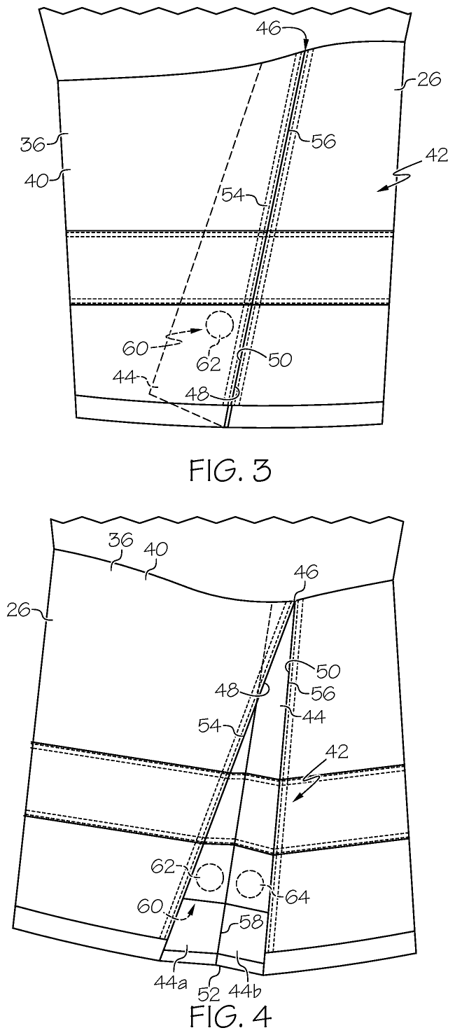

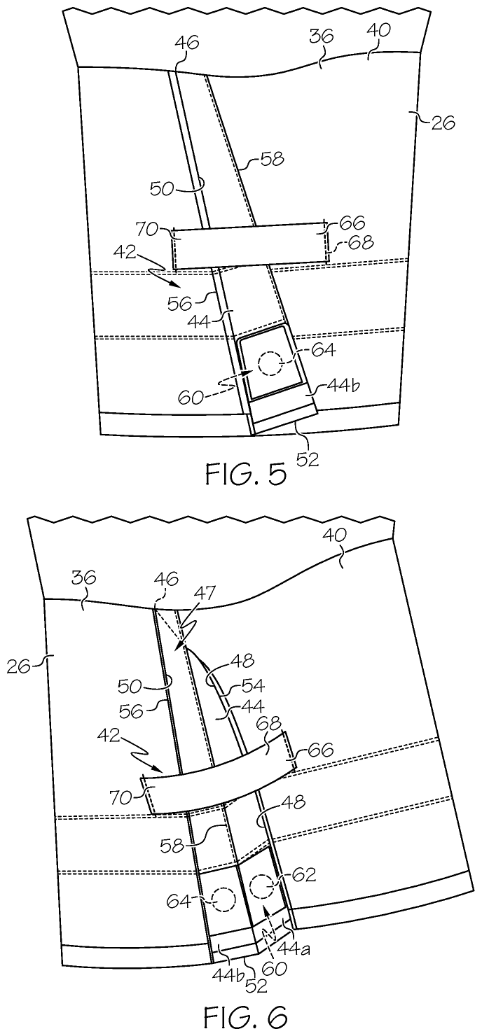

The coat 10 can include an adjustment system, generally designated 42, at a distal end of each sleeve 24. Similarly, the trousers 36 can include the adjustment system 42 located at a distal end of each leg 40. The adjustment system 42 can be adjusted as desired to vary an effective circumference of the sleeve 24/leg 40 without any manual operation by the wearer, and thus provide a tighter/smaller fit as desired by the wearer about the lower arm/wrist and lower leg, respectively (e.g. forms a smaller circumference/perimeter/effective perimeter). FIGS. 3-13 show an adjustment system 42 in conjunction with the trousers 36, but it should be understood that the adjustment system 42 when used with the coat 10 would appear substantially the same as shown in FIGS. 3-13.

With reference to FIG. 4, the adjustment system 42 can include a piece of expansion material 44 that is, in one case, generally triangular in shape when viewed from the outside of the trousers 36 in the illustrated embodiment. When the piece of expansion material 44 (or visible portions thereof) is triangular as shown, it can have an apex 46, a first side 48 and a second generally opposite side 50 defining an angle therebetween, and a bottom side or edge 52. The angle at the apex 46 can be between about five degrees and about forty degrees, in one case, and between about fifteen and about twenty degrees in another case, such that the first 48 and second 50 sides are generally parallel. The first side 48 of the piece of expansion material 44 is coupled to a corresponding first edge 54 of the outer shell 26 of the sleeve 24/leg 40, and the second side 50 of the piece of expansion material 44 is coupled to a corresponding second edge 56 of the outer shell 26. However the piece of expansion material 44 can have a variety of other shapes, such as trapezoidal, irregular, or have other configurations. In the configuration shown in FIG. 6, the upper portion of the first edge 54 extends vertically above and is positioned underneath a folded area 47 that can naturally form in the sleeve 24/leg 40/piece of expansion material 44 when in the illustrated configuration, such that the apex 46 is similarly positioned below the folded area 47 [not sure I entirely follow the configuration here. I thought you had provide me with a sample but I am not seeing it in our file—do you have the sample, and if so can you share?].

In one case, the piece of expansion material 44 is entirely located in the outer/lowermost 50% of the associated sleeve 24 or leg 40, and in another case is entirely located in the outer/lowermost 25% of the sleeve 24 or leg 40. The piece of expansion material 44, or at least the radially outer surface thereof, can be made of outer shell 26 as outlined above to provide continuous protection to the wearer. The piece of expansion material 44 can also include moisture barrier 28 material and/or thermal barrier 30 material positioned radially inside the outer shell 26 if desired.

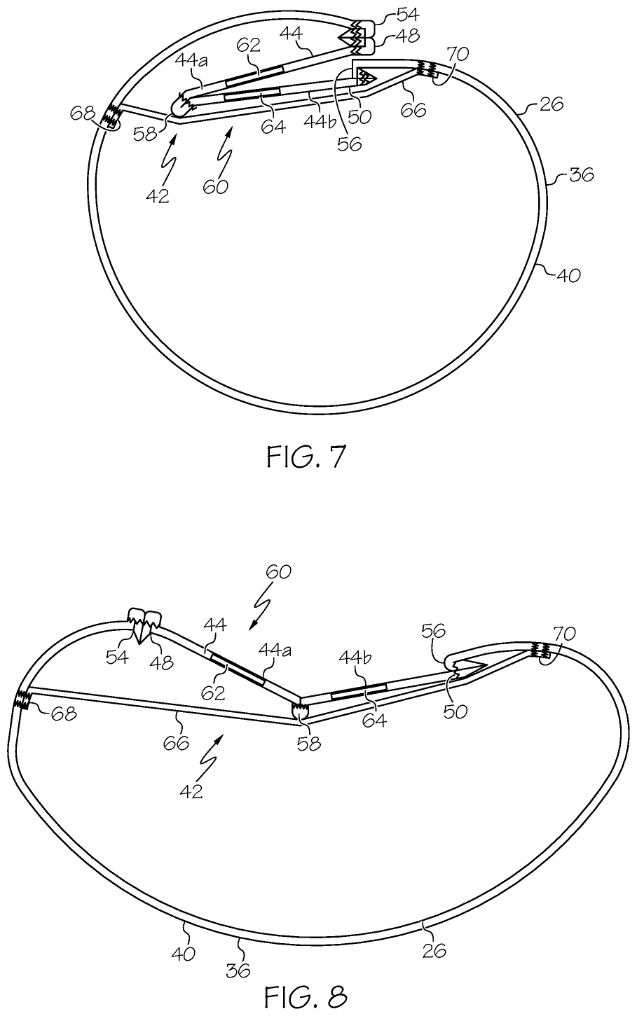

The piece of expansion material 44 can have a crease or fold 58 therein, in one case generally bisecting the angle/triangle, extending from the apex 46 thereof to the bottom edge 52. The crease or fold 58 forms or defines a line about which the piece of expansion material 44 is naturally inclined or predetermined to fold or bend, and thus forms a pivot axis. In one case, as shown in FIGS. 7 and 8, the crease or fold line 58 is defined by a seam formed in the piece of expansion material 44 where portions of the piece of expansion material 44 are coupled together. In another case, the crease or fold 58 can be formed by a permanent creasing such as by the application of heat and/or pressure and/or chemicals, or by forming or positioning an area of weakness and/or thinner material in the piece of expansion material 44. The crease or fold 58 thereby defines a first portion 44a located on a first side of the crease or fold 58 and a second portion 44b located on a second, opposite side of the crease or fold 58. In one case the piece of expansion material 44 is formed of a single, unitary seamless piece of material (seamless except where two portions 44a, 44b of the single piece of expansion material 44 are coupled to each other in the illustrated embodiment, as opposed to a seam that joins to separate pieces of material together) to provide continuous protection to the wearer.

The sleeve 24/leg 40/adjustment system 42/piece of expansion material 44 is movable, pivotable or foldable about the crease or fold 58 between a retracted position, as shown in FIGS. 1-3, 5 and 7, and an expanded position as shown in FIGS. 4, 6 and 8. When the piece of expansion material 44 is in the retracted position, the piece of expansion material 44 is folded about the crease or fold 58 such that the first 44a and second 44b portions are parallel or generally parallel (within about twenty degrees in one case, and within about ten degrees in another case) and generally facing each other or in facial contact, or the first 44a and second 44b portions are more parallel than when the piece of expansion material 44 is in the expanded position. Stated differently, when the piece of expansion material 44 is in the retracted position, in one case the first portion 44a and the second portion 44b are generally aligned and generally fully or at least partially overlap with each other in the radial direction such that a radial line passes through both the first portion 44a and the second portion 44b. In the illustrated embodiment, when the piece of expansion material 44 is in the retracted position, the first portion 44a is folded over (positioned radially outside) the second portion 44b. However, if desired this configuration can be reversed such that the second portion 44b is folded over (positioned radially outside) the first portion 44a. When the piece of expansion material 44 is in the retracted position, the effective circumference of the arm/sleeve 24 in that area is reduced, as shown in FIG. 7, to thereby form a relatively tight fit (or define a smaller circumference/perimeter/effective perimeter) about the wearer's leg or arm.

Conversely, when the sleeve 24/leg 40/adjustment system 42/piece of expansion material 44 is in the expanded position, the piece of expansion material 44 is unfolded about the crease or fold 58 such that the first 44a and second 44b portions are not folded about the crease or fold 58 (or are less folded as compared to when in the retracted position) and are parallel or generally parallel. In addition, when the sleeve 24/leg 40/adjustment system 42/piece of expansion material 44 is in the expanded position the piece of expansion material 44 may be in an arcuate or generally arcuate configuration, forming part of the outer perimeter/circumference of the legs 40/sleeve 24. Stated differently, when the piece of expansion material 44 is in the expanded position, in one case the first portion 44a and the second portion 44b are not generally aligned and do not generally fully overlap with each other in the radial direction (or less so as compared to when in the retracted position), and instead the first 44a and second 44b portions are adjacent to each other in the circumferential direction and generally aligned in the circumferential direction. When the piece of expansion material 44 is in the expanded position, the portions 44a, 44b may not overlap in the radial direction (or at least less so as compared to when in the retracted position), and the effective circumference of the arm/sleeve 24 in that vicinity is increased as shown in FIG. 8 to thereby form a relatively looser/larger fit (or define a larger outer perimeter) about the wearer's leg or arm.

When the piece of expansion material 44 is in the expanded position, the bottom edge 52 thereof can be generally aligned with and/or form part of an outer edge/hem of the associated sleeve 24 or leg 40. When the adjustment system 42 is used in the sleeve 24 of a coat 10 that utilizes wristlets 34, the wristlets 34 may be made of a sufficiently elastic/stretchable material to be able to receive and confirm around the wrist of a wearer when the associated piece of expansion material 44 in either the expanded position or the retracted position.

The sleeve 24/leg 40/adjustment system 42/piece of expansion material 44 may be desired to be in the expanded position when needed, for example to fit the sleeve 24/leg 40 about a glove or a boot during the donning or doffing of the coat 10/trousers 36, or when needed to accommodate the additional thickness provided by gloves or boots received inside the distal end of the sleeve 24/leg 40. In contrast, when the garment 10/36 is not being donned or doffed, or when the greater circumference is not needed for a proper fit, the sleeve 24/leg 40/adjustment system 42/piece of expansion material 44 can be positioned in the retracted position without any manual operation by the wearer (or indeed, without any operation by the wearer except perhaps movement or withdrawal of the hand/glove or leg/boot, in the axial direction) to ensure a tighter fit is provided about the wearer and provide greater protection, and to ensure that the legs 40/sleeves 24 are not so loose at the distal ends as to interfere with walking or other movement, and to reduce brushing of the legs 40/sleeves 24 against adjacent objects.

The sleeve 24/leg 40/adjustment system 42 can include a retaining system 60 configured to releasably retain the piece of expansion material 44 in the retracted position. In the illustrated embodiment, the retaining system 60 includes a first component 62 in the form of a first magnet, and a second component 64 in the form of second magnet or a piece of magnetizable material (such as a ferrous material) configured to magnetically interact with the first magnet 62. The first component 62 can be located on one of the first 44a or second 44b portions of the piece of expansion material 44, and the second component 64 can be located on the other one of the first 44a or second 44b portions. When two magnets are used as the two components 62, 64, the magnets are arranged such that their opposite poles are facing each other, to experience attractive forces, when the piece of expansion material 44 is in the retracted position.

In this manner, when the piece of expansion material 44 is in the retracted position, the first 62 and second 64 components interact to retain the piece of expansion material 44 in the retracted position. When it is desired to move the piece of expansion material 44 to the expanded position, the piece of expansion material 44 can be manually pulled into or toward the expanded position, thereby separating the first 62 and second 64 components until they no longer magnetically interact to pull or retain the piece of expansion material 44 in the retracted position.

The first 62 and second 64 components can be located on a radially outer surface and/or a radially inner surface of the piece of expansion material 44. Alternatively, when the first 62 and second 64 component of the retaining system 60 include or take the form of magnets/pieces of magnetizable material, the first 62 and second 64 components can be located radially inside the outermost layer of the piece of expansion material 44, and radially outside the innermost layer of the piece of expansion material 44 such that the first 62 and second 64 components are positioned/sandwiched inside the thickness of the piece of expansion material 44 (as shown in the embodiment of FIGS. 3-6). In this case the retaining system 60 is thereby relatively protected from moisture, abrasion, heat, chemicals and other forces/materials. The retaining system 60 can be spaced away from the outer/distal edge of the sleeve 24/leg 40/piece of expansion material 44 so that the retaining system 60 is thereby somewhat protected from moisture (e.g. standing water in the case of trousers 36), abrasion, heat, chemicals and other forces/materials. In addition, when the first 62 and second 64 components of the retaining system 60 include or take the form of magnets/pieces of magnetizable material, the retaining system 60 can be automatically operated without any manual operation, as the magnetic attraction automatically secures the first 62 and second 64 components together when they are located sufficient near each other.

The sleeve 24/leg 40/adjustment system 42 can include a biasing device 66 configured to bias the sleeve 24/leg 40/adjustment system 42/piece of expansion material 44 to the retracted position. In the illustrated embodiment the biasing device 66 includes or takes the form of a piece of elastic material that has first 68 and second 70 opposite ends attached to the leg 38/sleeve 24, at a location other than the piece of expansion material 44 in one case. In one case the first end 68 is coupled at or adjacent to (or closer to, as measured about an outer perimeter of the sleeve 24/leg 40) the first edge 54 of the outer shell 26 and the second end 70 is coupled at or adjacent to (or closer to) the second edge 56 of the outer shell 26. In this manner the piece of elastic material 66 can span the piece of expansion material 44 in the circumferential direction.

The piece of elastic material 66 is expandable/stretchable (the term “elastic” is used herein to encompass both terms). In one case the piece of elastic material 66 has an elasticity such that it can be extended in length in the circumferential direction (and/or in a length and/or width direction of the piece of elastic material 66) (i.e. in the direction of applied stretching forces) without breaking, but is biased to return to its original, un-biased shape/length. In one case the piece of elastic material 66 is stretchable by at least about 2% in one case, or at least about 5% in another case, or at least about 10% in yet another case along its length and/or width when stretching forces are applied, and is configured to return to its original, undeformed shape/position when stretching forces are no longer applied. In one case, the biasing device 66 is spaced away from the outer/lower/distal edge of the sleeve 24/leg 40/piece of expansion material 44 such that the biasing device 66 is thereby somewhat protected from moisture (e.g. standing water in the case of trousers), abrasion, heat, chemicals and other forces/materials.

The piece of elastic material 66 can be configured such that when the piece of expansion material 44 is in the expanded position the piece of elastic material 66 is in tension, and when the piece of expansion material 44 is in the retracted position the piece of elastic material 66 is not in tension (or is in less tension compared to when the piece of expansion material 44 is in the expanded position). In this manner the piece of elastic material/biasing device 66 biases the sleeve 24/leg 40/adjustment system 42/piece of expansion material 44 to the retracted position. The biasing device 66 can thereby operate without any manual operation or input from the wearer. The biasing device 66 thereby ensures that the piece of expansion material 44 does not remain in the expanded position when it is not needed (e.g. when the distal end of the sleeves 24/legs 40 are not positioned about gloves or boots), and instead moves away from the expanded position, toward or into the retracted position, to ensure a tighter fit is provided about the wearer and provide greater protection. This operation of the biasing device 66 can also ensure that the legs 40/sleeves 24 are not so loose at the distal ends as to interfere with walking or other movement, and to reduce brushing of the legs 40/sleeves 24 against adjacent objects.

The biasing device 66 can be located radially inside the outermost layer of the piece of expansion material 44, and in some cases can be located on the radially inner-most surface of the associated portion of the sleeve 24/leg 40 (see FIGS. 7 and 8) to ensure smooth movement of the biasing device 66 and to reduce catching/binding. In other cases the biasing device 66 can be located radially outside the innermost layer of the sleeve 24/leg 40/piece of expansion material 44 such that the biasing device 66 is positioned inside the thickness of the sleeve 24, leg 40 and/or piece of expansion material 44. In this case the biasing device 66 is thereby relatively protected from moisture, abrasion, heat, chemicals and other forces/materials. Moreover, it should be understood that the biasing device 66 can take various other forms besides the piece of elastic material, such as magnets/magnetizable components (beyond those of the retaining system 60, if any) that magnetically bias the piece of expansion material 44 to the retracted position.

The first 48 and second 50 sides and first 54 and second 56 edges can, in one case, be oriented at an angle relative to the inseam and/or outseam of the trousers 36/coat 10 such that, for example in the case of the trousers 36, the first 48 and second 50 sides and first 54 and second 56 edges are at an angle relative to a vertical frame of reference when the wearer is standing at rest. The outer shell 26, and/or other layers of the garment, are often made with material, such as fabric, that has a natural or inherent grain due to the manufacturing process, and a natural bias or drape at an angle of forty-five degrees to the grain of the fabric. The sleeves 24 and/or legs 40 are typically arranged such that the inseam and/or outseam is aligned with the grain of the fabric. By positioning the first 48 and second 50 sides and first 54 and second 56 edges at an angle as shown, the first 48 and second 50 sides and first 54 and second 56 edges are thereby positioned at an angle relative to the grain of the fabric, which aids in the movement of the piece of expansion material 44 to its retracted position, since the fabric will have a natural tendency to fold in the direction of FIG. 3 as compared to FIG. 4 due to the natural bias. The angle formed by the first 48 and second 50 sides and first 54 and second 56 edges with regard to the inseam/outseam and/or grain of the fabric is in one case between about five degrees and about twenty degrees, but can vary as desired. In addition, in another case the first 48 and second 50 sides and first 54 and second 56 edges do not form an angle with the inseam/outseam and/or bias or drape, and but are instead parallel or generally parallel with the inseam/outseam and/or bias or drape.

The adjustment system 42 can be positioned at nearly any circumferential position along the length/height of the associated sleeve 24/leg 40. When the adjustment system 42 is used with the trousers 36 the adjustment system 42 can in one case be located at or aligned with the outseam and/or inseam, or within about twenty five degrees of the outseam and/or inseam, as this may position the adjustment system 42 away from brushing the other leg 40 and/or potentially damaging environmental conditions or structures. Similarly, when the adjustment system 42 is used with the coat 10 the adjustment system 42 can in one case be located at or aligned with, or at least partially overlap with, the outseam or inseam of the coat 10, or within about twenty five degrees of the outseam or inseam to provide protection as outlined above.

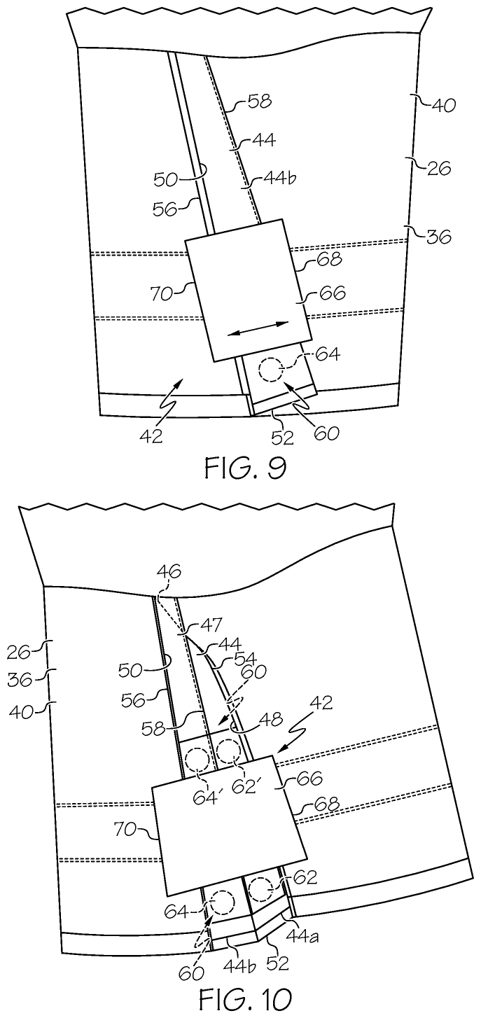

FIG. 9 illustrates an alternative embodiment where the biasing device 66/piece of elastic material 66 has a greater height, and extends for a further distance along the fold or crease, 58 as compared to the embodiment of FIGS. 3-8. This embodiment may provide a stronger retraction force, but may add bulk and/or expense.

FIG. 10 illustrates a further alternative embodiment, wherein the retaining system 60 includes additional (a third 62′ and a fourth 64′) components. The third 62′ and fourth 64′ components can be magnets or magnetically attractable components in the same manner as the first 62 and second 64 components described above, and are configured to magnetically interact with each other when the piece of expansion material 44 is in the retracted position and thereby secure the piece of expansion material 44 in the retracted position. This embodiment can help to ensure the piece of expansion material 44 is in the retracted position, but may add bulk and/or expense.

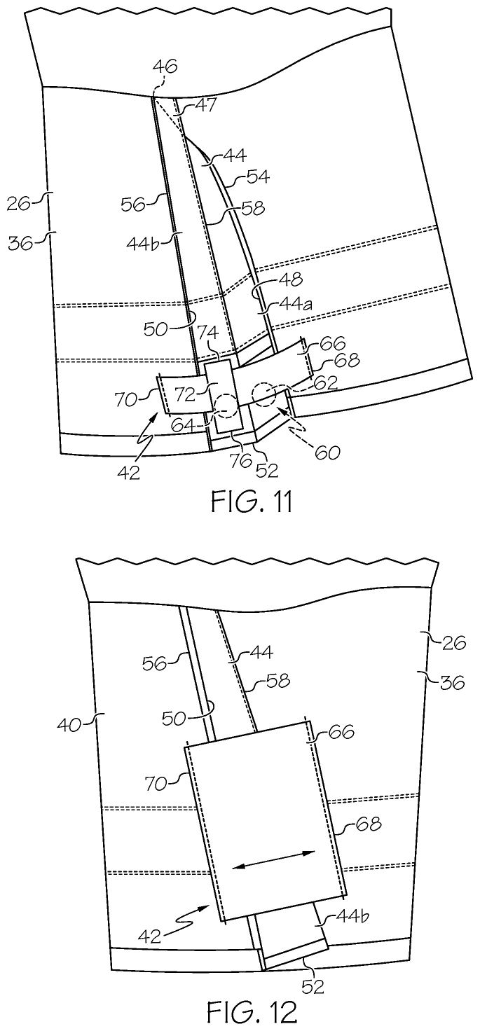

FIG. 11 illustrates a further alternative embodiment, wherein the retaining system 60 includes a retaining loop 72 that is coupled to the piece of expansion material 44 and extends in the vertical direction (when used with the trousers 36) or extends along the length of the sleeve 24/leg 40. The retaining loop 72 is coupled to the piece of expansion material 44 at its distal ends 74, 76, and not secured to the piece of expansion material 44 along its middle portion. In this manner the piece of elastic material 66 is passed under the retaining loop 72, and the retaining loop 72 thereby helps to retain the piece of elastic material 66 close against the sleeve 24/leg 40 so that the piece of elastic material 66 does not catch or snag on the wearer's footwear, or other loose items.

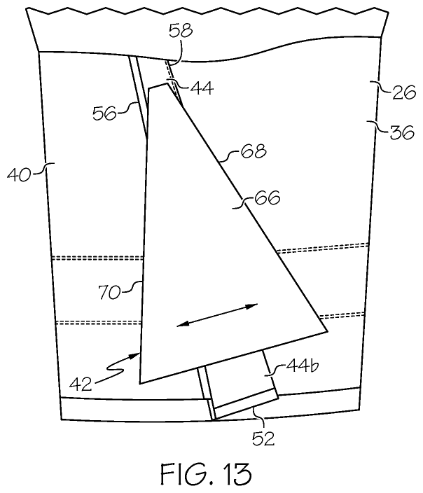

FIG. 12 illustrates a further alternative embodiment. In this embodiment, the biasing device 66 is included, in the form of the piece of elastic material having a generally rectangular shape in the illustrated embodiment, but the retaining system 60 is not included. In this embodiment the adjustment system 42 is thereby biased into the retracted position, and may be retained in the retracted position by the biasing device 66 alone. In this embodiment, the biasing device 66 is included, in the form of the piece of elastic material in the illustrated embodiment, but the retaining system 60 is not included. In this embodiment the adjustment system 42 is thereby biased into the retracted position, and may be retained in the retracted position by the biasing device 66 alone. FIG. 13 illustrates a further alternative embodiment in which the biasing device 66 has a greater height compared to the embodiment of FIG. 12, and has a generally triangular shape.

It should be noted that, while the garments 10, 36 are shown herein as including multiple layers, the garments 10, 36 can include only a single layer, such as an outer shell 26 only, with the adjustment system 42 being incorporated into the only layer/outer shell 26. In addition, when the garments 10, 36 have multiple layers, the adjustment system 42 can be used in any one, or multiple, of the layers. Thus by way of example the adjustment system 42 can be incorporated in any or more one of the outer shell 26, moisture barrier 28, thermal barrier 30 and/or face cloth 32.

Thus the adjustment system 42 provides a system in which the extremities 24, 40 are adjustable to adjust the fit of the garment 10, 36 to provide better comfort and safety. The adjustment system 42 is easy to implement and operate, and adds little weight or bulk.

Having described the invention in detail and by reference to the preferred embodiments, it will be apparent that modifications and variations thereof are possible without departing from the scope of the invention.

What is claimed is:

1. A protective garment comprising:
a body portion;
an extremity portion coupled to the body portion and being shaped and configured to receive a leg or an arm of a wearer therein;
a piece of expansion material coupled to the extremity portion, wherein the piece of expansion material is movable between a retracted position wherein the extremity portion is configured to form relatively smaller fit about the wearer's leg or arm, and an expanded position wherein the extremity portion is configured to form a relatively larger fit about the wearer's leg or arm;
a biasing device configured to bias the piece of expansion material to the retracted position; and
a retaining system configured to releasably retain the piece of expansion material in the retracted position.

2. The garment of claim 1 wherein when the piece of expansion material is configured such that when the piece of expansion material in the retracted position, at least two portions of the piece of expansion material overlap in a radial direction, and when the piece of expansion material is in the expanded position the at least two portions of the piece of expansion material do not overlap in the radial direction, or overlap to a lesser extent.

3. The garment of claim 1 wherein the piece of expansion material is located at a distal end of the extremity portion.

4. The garment of claim 1 wherein the piece of expansion material has a crease or fold therein, a first portion located on a first side of the crease or fold and a second portion located on a second, opposite side of the crease or fold, wherein when the piece of expansion material is in the retracted position, the piece of expansion material is folded about the crease or fold such that the first and second portions of the piece of expansion material are in facial contact or generally facing each other, and wherein when the piece of expansion material is in the expanded position, the first and second portions of the piece of expansion material are not in facial contact and are not generally facing each other.

5. The garment of claim 1 wherein the piece of expansion material has a crease or fold therein, a first portion located on a first side of the crease or fold and a second portion located on a second, opposite side of the crease or fold, wherein when the piece of expansion material is in the retracted position, the first portion and the second portion of the piece of expansion material are generally aligned and generally fully overlap with each other in a radial direction, and wherein when the piece of expansion material is in the expanded position, the first portion and the second portion of the piece of expansion material are not generally aligned and do not generally fully overlap with each other in the radial direction.

6. The garment of claim 5 wherein the crease or fold is formed by a seam in the piece of expansion material.

7. The garment of claim 1 wherein the piece of expansion material is generally triangular in outer view and has a first side coupled to the extremity portion and a second, generally opposite side coupled to the extremity portion.

8. The garment of claim 1 wherein an outer layer of the piece of expansion material is made of a same material as an outer layer of the extremity portion.

9. The garment of claim 1 wherein the biasing device is made of or includes elastic material.

10. The garment of claim 1 wherein the biasing device is made of or includes elastic material and is configured such that when piece of expansion material is in the expanded position the biasing device is in tension, and when piece of expansion material is in the retracted position the biasing device is not in tension or is in lesser tension.

11. The garment of claim 1 wherein the biasing device is made of or includes elastic material and has a first end coupled to the extremity portion on a first side of the piece of expansion material, and a second end coupled to the extremity portion on a second, opposite side of the piece of expansion material such that the retaining system spans the piece of expansion material.

12. The garment of claim 1 wherein the biasing device is positioned on a radially inner surface of the extremity.

13. The garment of claim 1 wherein the retaining system includes a magnet, and at least one of a supplemental magnet or a piece of magnetizable material.

14. The garment of claim 13 wherein the magnet, and the at least one of a supplemental magnet or a piece of magnetizable material, are both positioned on the piece of expansion material.

15. The garment of claim 13 wherein the piece of expansion material has a crease or fold therein, a first portion located on a first side of the crease or fold and a second portion located on a second, opposite side of the crease or fold, and wherein the magnet is located on one of the first or second portions, and wherein the supplemental magnet or piece of magnetizable material is positioned on the other one of the first or second portions.

16. The garment of claim 1 wherein the extremity is generally tubular and is configured to cover at least about 90% of the arm or leg of a wearer.

17. The garment of claim 1 wherein the garment is one of a firefighter coat or trousers including an outer shell that resists igniting, burning, melting, dripping, or separation when exposed to a temperature of 500° F. for five minutes, a thermal barrier having a TPP of at least about thirty five and configured to be positioned between the outer shell and a wearer of the coat, and a moisture barrier configured to permit moisture vapor to pass therethrough but block liquids from passing therethrough, wherein the moisture barrier is configured to be positioned between the outer shell and a wearer of the coat.

18. The garment of claim 1 wherein the piece of expansion material is coupled to the extremity portion along an edge of the extremity portion that is positioned at an angle relative to at least one of an inseam of the extremity portion, or at an angle relative to a grain of a fabric of the extremity portion.

19. The garment of claim 1 wherein the garment is configured such that when the piece of expansion material is in the retracted position the extremity portion has a smaller effective outer perimeter as compared to when the piece of expansion material is in the expanded position.

20. A method for manipulating a protective garment comprising:
accessing a protective garment having a body portion, an extremity portion coupled to the body portion and being shaped and configured to receive a leg or an arm of a wearer therein, and a piece of expansion material coupled to the extremity portion, wherein the piece of expansion material is movable between a retracted position wherein the extremity portion forms relatively smaller fit about the wearer's leg or arm, and an expanded position wherein the extremity portion forms a relatively larger fit about the wearer's leg or arm, the protective garment further including a biasing device configured to bias the piece of expansion material to the retracted position, and a retaining system configured to releasably retain the piece of expansion material in the retracted position; and
enabling the piece of expansion material to move between the retracted position and the expanded position.

21. The method of claim 20 wherein the piece of expansion material is configured to move from the expanded position to the retracted position without any manual interaction.

22. The method of claim 20 wherein when the piece of expansion material is configured such that when the piece of expansion material is in the retracted position, portions of the piece of expansion material overlap in a radial direction, and when the piece of expansion material is in the expanded position the portions of the piece of expansion material do not overlap in the radial direction or overlap to a lesser extent.

23. A protective garment comprising:
a body portion;
an extremity portion coupled to the body portion and being shaped and configured to receive a leg or an arm of a wearer therein;
a piece of expansion material coupled to the extremity portion, wherein the piece of expansion material is movable between a retracted position wherein the extremity portion forms a relatively smaller fit about the wearer's leg or arm, and an expanded position wherein the extremity portion forms a relatively larger fit about the wearer's leg or arm; and
a biasing device configured to bias the piece of expansion material to the retracted position.

24. The garment of claim 23 wherein the biasing device is made of or includes elastic material and is configured such that when the piece of expansion material is in the expanded position the elastic material is in tension, and when the piece of expansion material is in the retracted position the elastic material is not in tension or is in lesser tension.

25. The garment of claim 23 further including a retaining system configured to releasably retain the piece of expansion material in the retracted position.
